(19) United States
(12) Patent Application Publication
(10) Pub. No.: US 2004/0250040 A1
(43) Pub. Date: Dec. 9, 2004

(54) Pipline memory device

(76) Inventor: Du-Yeul Kim, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/824,401

(22) Filed: Apr. 15, 2004

(30) Foreign Application Priority Data
Jun. 5, 2003 (KR) 2003-36335

(51) Int. Cl. G06F 12/00

(52) U.S. Cl. 711/169

(57) ABSTRACT

A pipeline memory device including a data fetching control circuit and utilizes a data fetching method. The pipeline memory device includes a first, second, and third pipeline stages. A second pipeline control signal, for operating the second pipeline stage, is generated from a first pipeline control signal. The data fetching control circuit includes the following: A first edge trigger delay circuit that receives the clock signal for generating the first pipeline control signal and generates the first pipeline control signal. A second edge trigger delay circuit that receives the clock signal for generating the first pipeline control signal. A first inverter that inverts the first pipeline control signal. A NAND gate that inputs the outputs of the first inverter and the second edge trigger delay circuit. A second inverter that inverts the output of the NAND gate to output the second pipeline control signal. A time margin between the first pipeline control signal and the second pipeline control signal can be broadened for high-frequency operation because the second pipeline control signal is activated depending on the point of activation of the first pipeline control signal.

### BACKGROUND OF THE INVENTION

1. Field of the Invention

Embodiments of the present invention relate to a pipeline memory device having a data fetching control circuit and utilizing a data fetching control method.

This application claims the priority of Korean Patent Application No. 2003-36335 filed on Jun. 5, 2003 in the Korean Intellectual Property Office, the disclosure of which is incorporated herein in its entirety by reference.

2. Description of the Related Art

Electronic systems used in computers, communication systems, and other industrial equipment have become larger and more advanced. These electronic systems are supported by semiconductor memory devices, capable of storing large quantities of data and operating at high speeds. Pipeline configurations in semiconductor memory devices is a relatively new technology that increases the speed of semiconductor memory devices.

FIG. 1 is an exemplary block diagram of a memory device with a pipeline configuration. The pipeline memory device 10 receives an address signal ADD through the address buffer 12 and the address register 14. The received address signal ADD addresses the memory cell 21 by the row decoder 18 and the column decoder 20 via the address pre-decoder 16. In response to a clock signal CLK and a command signal CMD, the synchronous control circuit 15 generates a first pipeline control signal FRP, a second pipeline control signal SRP, and a data output clock signal (CLKDQ).

The address register 14 latches the received address signal ADD. The column decoder 20 addresses a predetermined number of memory cells by sequentially increasing a column address in response to an address increment signal INCREMENT. The sense amplifier 24 senses and amplifies data of the selected memory cells and outputs the amplified data to the data pipeline stage 32. The data pipeline stage 32 transfers the data received from the sense amplifier 24 to the data output buffer 34 by sequentially fetching the data in response to the first pipeline control signal FRP, the second pipeline control signal SRP, and the data output clock signal CLKDQ. The data pipeline stage 32 comprises first, second and third stages 26, 28, and 30, in a row, that transfer the output data from a preceding stage to a subsequent stage, in response to the first pipeline control signal FRP, the second pipeline control signal SRP, and the data output clock signal CLKDQ.

FIG. 2 is an exemplary timing diagram for a read operation of the pipeline memory device 10 of FIG. 1. During a read operation, memory cell data selected in response to sequentially input clock signals CLK is transferred to the data output pad DQ. For example, in the clock period C0, the address signal ADD is latched. The word line WL of a memory cell corresponding to the clock period C0 is enabled and the memory cell data is charge-shared into the bit line BL and the complemented bit line BLB. In the clock period C1, the first pipeline control signal FRP is generated in a delayed response to the rising edge of the clock pulse in clock period C0. The second pipeline control signal SRP is generated in response to the rising edge of the clock pulse in the clock period C1. In the clock period C2, the data output clock signal CLKDQ is generated in response to the rising edge of the clock pulse in the clock period C2. The first data D0 is transferred to the data output pad DQ in response to the data output clock signal CLKDQ.

In order to output the data of the memory cells (e.g. the data of four memory cells D0, D1, D2, and D3) the first and second pipeline control signals FRP and SRP and the data output clock signal CLKDQ are generated sequentially. Each of the signals FRP, SRP, and CLKDQ is generated one time for each output data (e.g. D0, D1, D2, or D3) processed by the pipeline memory device 10. Data D0, D1, D2, and D3 are output to the data output pad DQ, in response to the data output clock signal CLKDQ generated during clock periods C2, C3, C4, and C5.

An absolute time margin ΔT1 is required between when the second pipeline control signal SRP is deactivated and when the next occurring first pipeline control signal FRP is activated. In other words, activation of the first pipeline control signal FRP and the second pipeline control signal SRP, corresponding to different output data (e.g. D0, D1, D2, or D3), should not overlap.

FIG. 3 shows an edge trigger delay circuit 300. The edge trigger delay circuit 300 generates the first or second pipeline control signals FRP and SRP. The edge trigger delay circuit 300 generates the first pipeline control signal FRP or the second pipeline control signal SRP, independently, in response to an internal clock signal PCLK. PCLK is generated by synchronization with the clock signal CLK. However, when the pipeline memory device 10 is required to operate at higher frequencies, the absolute time margin ΔT1 becomes shorter and may ultimately limits high-frequency operation. Therefore, a pipeline memory device employing a data fetching method that does not limit high-frequency operation is desirable.

### SUMMARY OF THE INVENTION

Embodiments of the present invention provide a pipeline memory device having a data fetching control circuit and utilizing a data fetching control method. In accordance with aspects of embodiments of the present invention, a pipeline memory device comprises the following: A plurality of memory cells that store data. A data transfer path on which the data is transferred. A data fetching control circuit that generates a first pipeline control signal, in response to a clock signal for generating a first pipeline control signal. The data fetching control circuit also generates a second pipeline control signal, in response to both the clock signal for generating the second pipeline control signal and the first pipeline control signal. A first pipeline stage that latches the data on the data transfer path in response to the first pipeline control signal. A second pipeline stage that latches the data latched by the first pipeline stage in response to the second pipeline control signal. A third pipeline stage that outputs the data latched by the second pipeline stage to a data output pad in response to a data output clock signal.

The data fetching control circuit may comprise the following: A first edge trigger delay circuit that receives the clock signal for generating the first pipeline control signal and generates the first pipeline control signal. A second edge trigger delay circuit that receives the clock signal for generating the first pipeline control signal. A first inverter that inverts the first pipeline control signal. A NAND gate that inputs the outputs of the first inverter and the second edge trigger delay circuit. A second inverter that inverts the output of the NAND gate to output the second pipeline control signal.

According to aspects of embodiments of the present invention, a data fetching method comprises the following: Transferring data stored in memory cells along a transfer path. Generating a first pipeline control signal in response to a clock signal for generating a first pipeline control signal. Generating a second pipeline control signal in response to the clock signal for generating a second pipeline control signal and the first pipeline control signal. Latching the data to a first pipeline stage on the transfer path in response to the first pipeline control signal. Latching the data to a second pipeline stage on the transfer path in response to the second pipeline control signal. Outputting the data from the second pipeline stage to a data output pad in response to a data output clock signal. A point of activation of the second pipeline control signal is determined depending on a point of activation of the first pipeline control signal, such that the second pipeline control signal is activated after the first pipeline control signal is deactivated.

In the related art, the time gap between the first pipeline control signal and the second pipeline control signal (i.e., the absolute time margin ΔT1), is a factor limiting the operating frequency of the pipeline memory device. According to embodiments of the present invention, the absolute time margin can be replaced with a time gap between the first pipeline control signal FRP and the second pipeline control signal SRP that can be broadened, because the second pipeline control signal is activated depending on the point of activation of the first pipeline control signal. Thus, a pipeline memory device according to the present invention can be operated at higher frequencies than the related art pipeline memory device.

### BRIEF DESCRIPTION OF THE DRAWINGS

FIG. 1 is block diagram of a memory device with a pipeline configuration.

FIG. 2 is a timing diagram for a read operation of the pipeline memory device of FIG. 1.

FIG. 3 is an edge trigger delay circuit generating first and second pipeline control signals in the pipeline memory device of FIG. 1.

FIG. 4 is an exemplary conceptual drawing of a data fetching method applied to a pipeline memory device.

FIGS. 5 and 6 illustrate exemplary data fetching control circuits.

FIG. 7 is an exemplary timing diagram for operation of a pipeline memory device that employs the exemplary data fetching control circuit of FIG. 6.

### DETAILED DESCRIPTION OF THE INVENTION

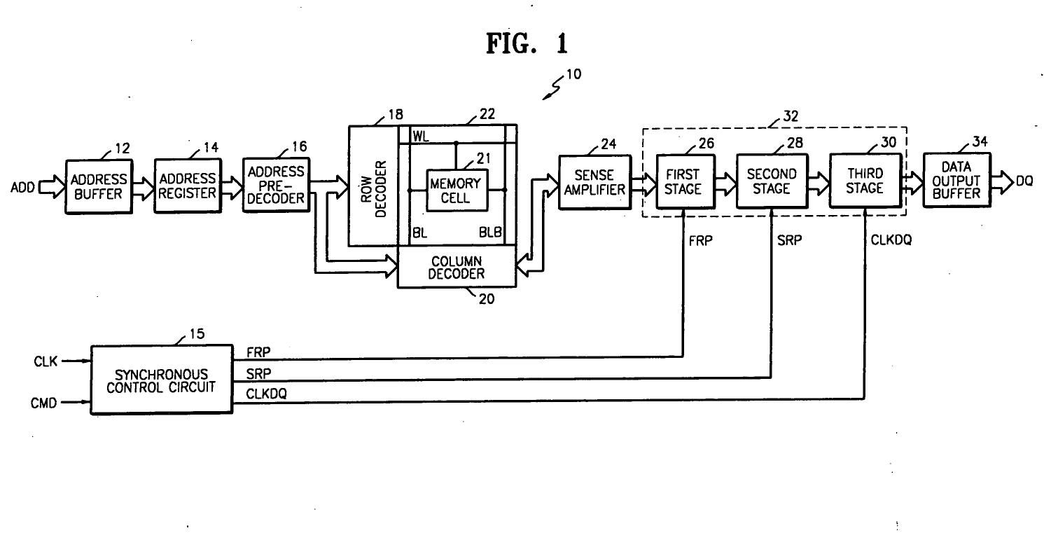

FIG. 4 is an exemplary conceptual drawing of a data fetching method applied to a pipeline memory device, according to embodiments of the present invention. In FIG. 4, the data pipeline stage 32 consists of the first, second, and third pipeline stages 26, 28, and 30, similar to in FIG. 1. However, in FIG. 4, the second pipeline control signal SRP for operating the second pipeline stage 28 is generated from the first pipeline control signal FRP.

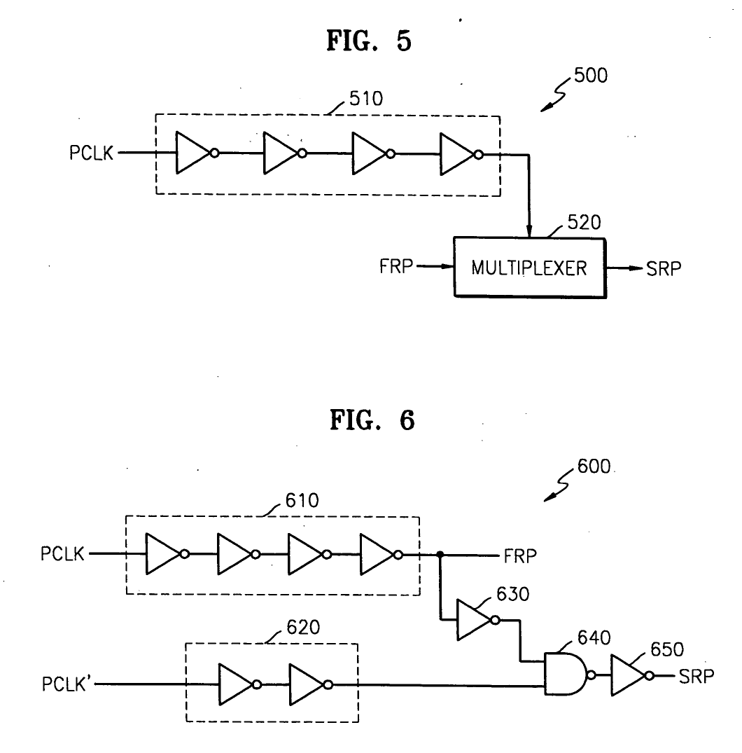

FIG. 5 is an exemplary circuit diagram of a data fetching control circuit 500, according to a embodiments of the present invention. In the data fetching control circuit 500, the first pipeline control signal FRP and an output signal from an edge trigger delay circuit 510 are transferred to a multiplexer 520. The edge trigger delay circuit 510 is generated by inputting an internal clock signal PCLK. The multiplexer 520 generates the second pipeline control signal SRP by multiplexing the first pipeline control signal FRP and the output of the edge trigger delay circuit 510. Accordingly, the second pipeline control signal SRP (for operating the second pipeline stage) is generated from the first pipeline control signal FRP that operates the first pipeline stage 26.

FIG. 6 is an exemplary circuit diagram of the data fetching control circuit 600, according to embodiments of the present invention. The data fetching control circuit 600 comprises the first edge trigger control circuit 610, the second edge trigger control circuit 620, the first inverter 630, the NAND gate 640, and the second inverter 650. The first edge trigger delay circuit 610 receives the first internal clock signal PCLK and generates the first pipeline control signal FRP. The second edge trigger delay circuit 620 receives a second internal clock signal PCLK′. PCLK′ has a predetermined delay with respect to the first internal clock signal PCLK and generates an intermediate signal. The first and the second edge trigger circuits 610 and 620 each consist of a chain of inverters (an even number of inverters). The first inverter 630 inverts the first pipeline control signal FRP and outputs the result to the NAND gate 640. The NAND gate 640 performs a NAND operation on the output of the first inverter 630 and the intermediate signal output by the second edge trigger delay circuit 620. The output of NAND gate 640 is input into the second inverter 650. The second inverter 650 generates the second pipeline control signal SRP by inverting the output of the NAND gate 640.

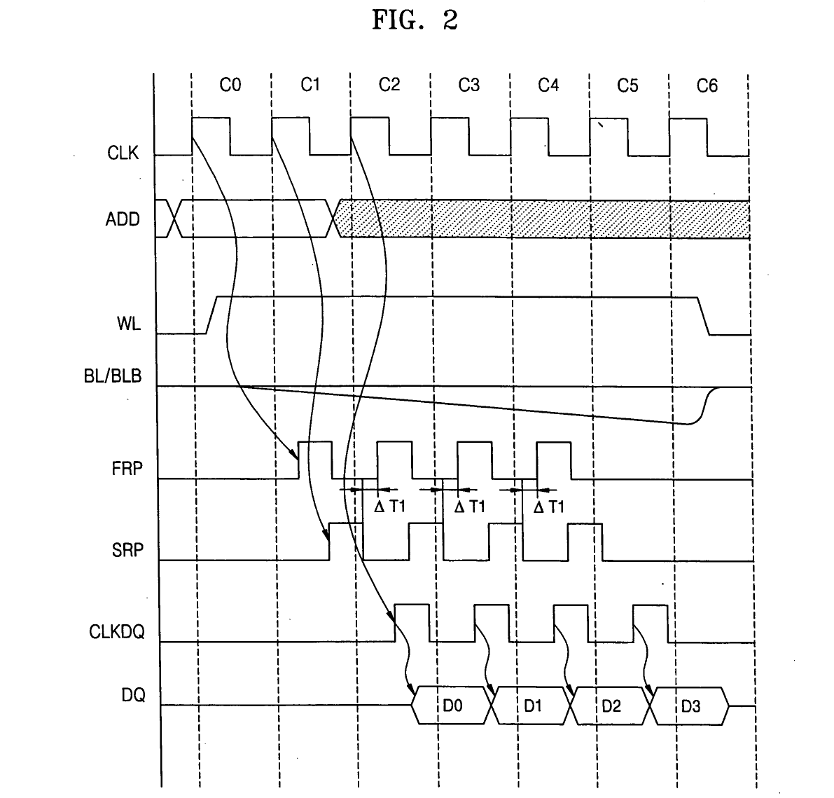

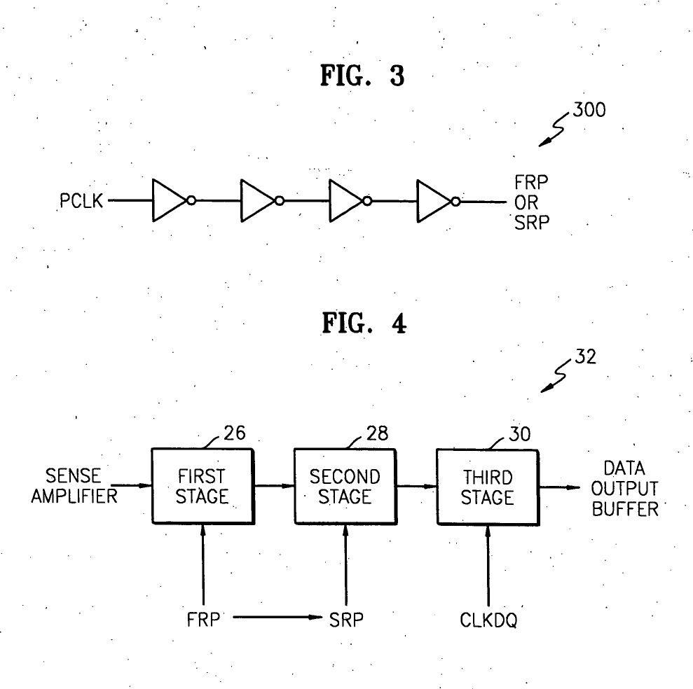

The data fetching control circuit 600 generates the second pipeline control signal SRP according to the output of the second edge trigger delay circuit 620 while the first pipeline control signal FRP is inactive (i.e. the FRP is in a logic “low” state). Accordingly, since the first pipeline control signal FRP and the second control signal SRP are generated independently, accommodating for the absolute time margin ΔT1 not required, as shown in FIG. 2. In the data fetch circuit 600, according to embodiments of the present invention, the duration of activation of the second pipeline control signal SRP and the duration of activation of the first pipeline control signal never overlap.

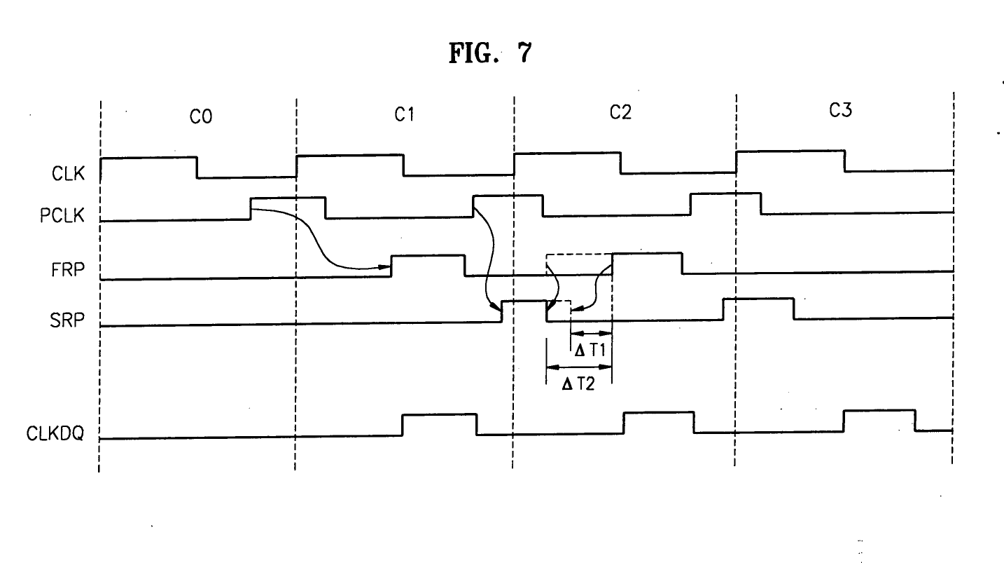

FIG. 7 is an exemplary timing diagram for operation of a pipeline memory device employing the data fetching control circuit 600 of FIG. 6. In response to the clock signal CLK input from outside the pipeline memory device, an internal clock signal PCLK is generated. In order to latch the data in the data transfer path, the first pipeline control signal FRP is generated in response to the first internal clock signal PCLK. After a delay, the second pipeline control signal SRP is generated in response to the second internal clock signal PCLK′, while the first pipeline control signal FRP is inactive (i.e. the FRP is in a logic “low” state).

As indicated by a dotted line in FIG. 7, the early generation of the first pipeline control signal FRP can be generated by applying a higher operating frequency to the pipeline memory device. Accordingly, the pulse width of the second pipeline control signal SRP can be reduced. In other words, depending on the point at which the first pipeline control signal FRP is activated, the second pipeline control signal SRP is deactivated. In this way, a time margin ΔT2 between the first pipeline control signal FRP and the second pipeline control signal SRP (similar to the absolute time margin ΔT1 of the related art) can be broadened.

In the related art, the time gap between the first pipeline control signal and the second pipeline control signal (i.e. the absolute time margin ΔT1) is a factor limiting the operating frequency of the pipeline memory device. According to embodiments of the present invention, the absolute time margin can be replaced with a time gap between the first pipeline control signal FRP and the second pipeline control signal SRP, which can be broadened. Thus, a pipeline memory device according to embodiments the present invention can operate at higher frequencies than a related art pipeline memory device.

While the present invention has been particularly shown and described with reference to preferred embodiments thereof, it will be understood by those skilled in the art that various changes in form and details may be made therein without departing from the sprit and scope of the invention as defined by the appended claims.

What is claimed is:

1. A pipeline memory device comprising:
a plurality of memory cells that store data;
a data transfer path on which the data is transferred;
a data fetching control circuit which generates:
a first pipeline control signal, in response to a first clock signal for generating the first pipeline control signal: and
a second pipeline control signal, in response to both a second clock signal for generating the second pipeline control signal and the first pipeline control signal;
a first pipeline stage which latches the data on the data transfer path in response to the first pipeline control signal;
a second pipeline stage which latches the data latched by the first pipeline stage in response to the second pipeline control signal; and
a third pipeline stage which outputs the data latched by the second pipeline stage to a data output pad in response to a data output clock signal.

2. The pipeline memory device of claim 1, wherein the data fetching control circuit comprises:
a first edge trigger delay circuit which receives the first clock signal for generating the first pipeline control signal and generates the first pipeline control signal; and
a multiplexer which receives the second clock signal for generating the second pipeline control signal and the first pipeline control signal, and generates the second pipeline control signal.

3. The pipeline memory device of claim 2, wherein the first and second edge trigger delay circuits compromise an even number of inverters in a chain.

4. The pipeline memory device of claim 1, wherein the data fetching control circuit comprises:
a first edge trigger delay circuit that receives the first clock signal for generating the first pipeline control signal and generates the first pipeline control signal;
a second edge trigger delay circuit that receives the second clock signal for generating the second pipeline control signal;
a first inverter that inverts the first pipeline control signal;
a NAND gate that receives the output of the first inverter and the second edge trigger delay circuit; and
a second inverter that inverts the output of the NAND gate to output the second pipeline control signal.

5. The pipeline memory device of claim 4, wherein the first and second edge trigger delay circuits compromise an even number of inverters in a chain.

6. A data fetching method for a pipeline memory device, comprising:
transferring data stored in memory cells along a transfer path;
generating a first pipeline control signal in response to a first clock signal for generating a first pipeline control signal;
generating a second pipeline control signal in response to a second clock signal for generating a second pipeline control signal and the first pipeline control signal;
latching the data to a first pipeline stage on the transfer path in response to the first pipeline control signal;
latching the data to a second pipeline stage on the transfer path in response to the second pipeline control signal; and
outputting the data from the second pipeline stage to a data output pad in response to a data output clock signal.

7. The method of claim 6, wherein a point of activation of the second pipeline control signal is determined depending on a point of activation of the first pipeline control signal.

8. The method of claim 6, wherein the second pipeline control signal is activated when the first pipeline control signal is inactive.

9. An apparatus comprising:
at least one memory cell;
a first pipeline stage coupled to the output of the at least one memory cell, wherein the first pipeline stage is driven by a first control signal; and
a second pipeline stage coupled to the output of the first pipeline stage, wherein the second pipeline stage is driven by the first control signal and a second control signal.

10. The apparatus of claim 9, wherein the first control signal and the second control signal are driven by a clock signal.

11. The apparatus of claim 10, wherein the clock signal is an internal clock signal.

12. The apparatus of claim 10, wherein:
the first control signal is delayed from the clock signal by a first delay; and
the second control signal is delayed from the clock signal by a second delay.

13. The apparatus of claim 12, wherein the first delay is larger than the second delay.

14. The apparatus of claim 9, wherein the first control signal and the second control signal are never in an active state at the same time.

15. The apparatus of claim 9, wherein the second pipeline stage is driven by the first control signal and the second control signal utilizing a multiplexer.

16. The apparatus of claim 9, wherein the second pipeline stage is driven by the first control signal and the second control signal utilizing NAND gate.
